(19) United States
(12) Patent Application Publication
(10) Pub. No.: US 2008/0147505 A1
(43) Pub. Date: Jun. 19, 2008

(54) STREAMING MOBILE ADVERTISING

(75) Inventor: Roger Davis, Marina Del Rey, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: XERO MOBILE INC., Beverly Hills, CA (US)

(21) Appl. No.: 11/953,834

(22) Filed: Dec. 10, 2007

Related U.S. Application Data
(60) Provisional application No. 60/869,814, filed on Dec. 13, 2006.
(60) Provisional application No. 60/869,823, filed on Dec. 13, 2006.
(60) Provisional application No. 60/869,828, filed on Dec. 13, 2006.
(60) Provisional application No. 60/869,830, filed on Dec. 13, 2006.
(60) Provisional application No. 60/869,835, filed on Dec. 13, 2006.
(60) Provisional application No. 60/869,838, filed on Dec. 13, 2006.
(60) Provisional application No. 60/869,840, filed on Dec. 13, 2006.
(60) Provisional application No. 60/869,843, filed on Dec. 13, 2006.

(51) Int. Cl. G06Q 30/00

(52) U.S. Cl. 705/14

(57) ABSTRACT

The disclosed method includes collecting and monitoring customer preferences; performing calculations based on the collected and monitored preferences, the calculations being for determining at least a target audience of the advertisement campaign, an advertisement media presentation, an advertisement media delivery time and an expense minimizing advertisement media delivery route for advertisements to be transmitted to a portable communication device to customers based on the individual customer's preferences through a network; and receiving and outputting the advertisements on the portable communication device.

### RELATED APPLICATION

This application claims the benefit of and priority to U.S. Provisional Application Ser. No. 60/869,814, filed Dec. 13, 2006, U.S. Provisional Application Ser. No. 60/869,823, filed Dec. 13, 2006, U.S. Provisional Application Ser. No. 60/869,828, filed Dec. 13, 2006, U.S. Provisional Application Ser. No. 60/869,830, filed Dec. 13, 2006, U.S. Provisional Application Ser. No. 60/869,835, filed Dec. 13, 2006, U.S. Provisional Application Ser. No. 60/869,838, filed Dec. 13, 2006, U.S. Provisional Application Ser. No. 60/869,840, filed Dec. 13, 2006, and U.S. Provisional Application Ser. No. 60/869,843, filed Dec. 13, 2006, the contents of which are incorporated by reference herein in their entirety.

### BACKGROUND

1. Field

The present disclosure relates to a method of advertising and more particularly to a method of cost optimizing advertising on a portable communication device.

2. General Background

Conventional advertisements, generally, are loosely based on general market profiles, viewing habits and/or demographics and, therefore, the advertisements do not always correlate well with the individual consumer's interests or preferences.

A lot of money is spent collecting data associated with the habits of consumers and even more is spent delivering advertisement campaigns that may only be effective to a small segment of the population.

More particularly, in the area of internet advertising, intrusive advertisements (pop-ups and spam) are particularly common. This form of advertising is seldom effective and can even be damaging due to the irritation the advertisements may cause an individual browsing the web.

To make advertisements more appealing to consumers, advertisers have developed television quality media clips that can be played through devices such as cell phones. A challenge exists in optimizing the quality, functionality and cost of playing television quality media clips through a portable communication device. Previous systems have relied on compressing the media data and sending the compressed bundle as a download to the device with a set play time. This approach is memory exhaustive and the data is usually sent for download in the middle of the night (off peak time), therefore, the media being sent may, in some instances, become out dated.

A need, therefore, exists in the art for an improved method for advertising that presents efficiently targeted advertisements to consumers particularly catered to their individual preferences and behavioral patterns in a substantially time precise and cost effective manner.

### SUMMARY

The disclosed method includes collecting and monitoring customer preferences; performing calculations based on the collected and monitored preferences, the calculations being for determining at least a target audience of the advertisement campaign, an advertisement media presentation, an advertisement media delivery time and a time minimizing advertisement media delivery route for advertisements to be transmitted to a portable communication device, based on an individual user's preferences, through a streaming data network; and receiving and outputting the advertisements on the portable communication device.

Other aspects, advantages, and novel features of the disclosure are described below or will be readily apparent to those skilled in the art from the following specifications and drawings of illustrative embodiments.

### DRAWINGS

The above-mentioned features and objects of the present disclosure will become more apparent with reference to the following description taken in conjunction with the accompanying drawings wherein like reference numerals denote like elements and in which:

FIG. 1 is a illustrative block diagram of a system for advertising in accordance with the present disclosure.

FIG. 2 is an illustrative process flow operation diagram in accordance with the present disclosure.

FIG. 3 is an illustrative process flow operation diagram in accordance with the present disclosure.

FIG. 4 is an illustrative process flow operation diagram in accordance with the present disclosure

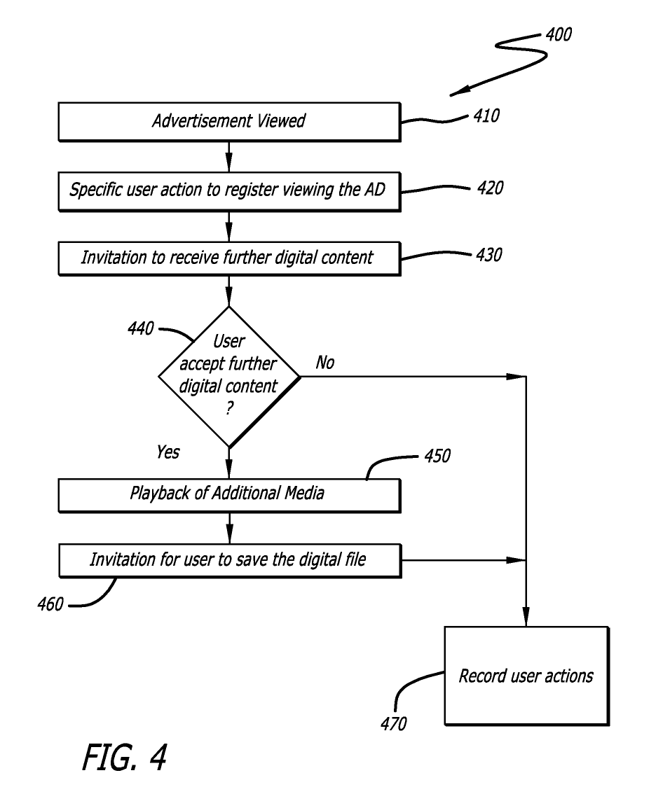

### DETAILED DESCRIPTION

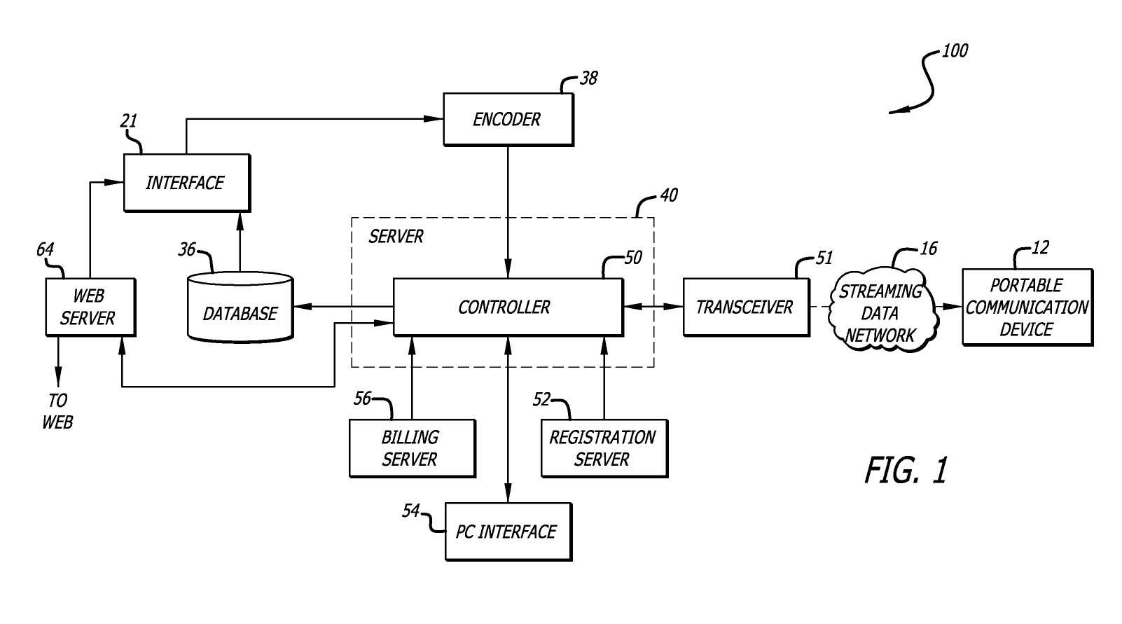

FIG. 1 is a block diagram showing an illustrative system for advertising. The system 100 includes an encoder 38, for receiving advertisement information through a client interface 21. The interface 21 may be a web interface, or alternatively, advertisement information may be provided on a disk or other means. The encoder 38 being for encoding the advertisement information and storing the same in a database 36. The server 40 being coupled with a controller 50 which acts as a scheduler and performs calculations.

The advertisements, in accordance with the present disclosure, are multimedia data files, wherein multimedia is media that uses multiple forms of information content and information processing (e.g. text, audio, graphics, animation, video, interactivity) to inform or entertain a user. The advertisements themselves may at least be related to consumer goods, products, food, movie's, special events, concerts and other entertainment applications that are known in the areas of marketing and advertising. In this disclosure, the term advertisement, advertisement media, multimedia data or digital media data may be used interchangeably. The disclosed method is for providing a method for advertising, but all the advertisements, in accordance with this disclosure, are in the form of multimedia data files or digital media data files.

The system 100 further includes a feedback database for storing data relating to user responses to the multimedia advertisements, a registration server 52, a PC user interface 54, a billing server 56 and a web server 64.

The system 100 being in communication with a portable communication device 12, preferably, through a streaming data network. The streaming data network being for streaming multimedia advertisements to the portable communication device 12, for minimizing memory usage and for being able to send multimedia as quickly as possible.

Preferably, the streaming data network technology is WIMAX (IEEE802.16x), but other wireless communication protocols may be utilized, technologies such as WiFi (EEE802.11x) or GPRS (General Packet Radio Service).

WiMAX describes a standard, interoperable implementations of IEEE802.16 wireless networks, similar to the way Wi-Fi is used for interoperable implementations of the IEEE802.11 Wireless LAN standard. WiMAX is functionally different from Wi-Fi. WiMAX uses a scheduling algorithm for which the subscriber station only has to compete once (for initial entry into the network). Upon entry, it is provided an access slot by the base station. The time slot can enlarge and contract, but remains assigned to the subscriber station, which means other subscribers are barred from use. In addition to being stable under overload and over-subscription (unlike 802.11), WIMAX's scheduling algorithm can also be more bandwidth efficient. The scheduling algorithm allows the base station to control QoS parameters by balancing the time-slot assignments among the application needs of the subscriber stations.

WiMAX is, therefore, able to provide a portable communication device with streaming television quality multimedia content that is substantially updated instantaneously in real time and minimizing the amount of memory on a portable communications device necessary to output such data intensive multimedia.

Alternatively, compression technology may also be utilized to send the multimedia advertisements. A system utilizing compression technology would require an encoder for receiving multimedia content via an interface. The interface being connected to the internet via a web server. As an alternative, the content may be provided via a disk or other means. The encoder being for encoding and compressing the content and storing the content in a server. For example, a 10-30 second file might be compressed into 150-300 kilobyte packet. The server would be in communication with a storage facility or database. The compressed multimedia data would then be sent to a portable communication device and downloaded by the same and programmed to initiate playback of the media at a predetermined time.

However, utilizing a streaming data network technology allows for substantially real-time updates, in addition to providing television quality advertisements, location specific emergency information may also be delivered to the user of a portable communication device 12. Multimedia advertisement and emergency information may be deliverable in less than 5 minutes or instantaneously to the portable communication device 12.

The portable communication device of the present disclosure is preferably a cell phone and is single hand operable and single hand portable, however, the portable communications may be, but is not limited to, a Personal Digital Assistants, a laptop etc. Generally, the device needs a cellular transceiver, onboard processor, memory, display, speakers, a user interface and, preferably, Global Positioning System (GPS) functionality. The data may be transferable to a home computer or laptop, allowing the user to transfer multimedia data from the portable communication device 12 and view the media on a home computer or laptop.

In this disclosure, reference is made to an advertiser or advertising entity and to a client or client of the system 100. They are to be understood as the same entity for the purposes of this disclosure. References is also made to the system 100 monitoring user activity for gathering user data associated with user preferences and actions in order to deliver specifically catered multimedia advertisements. In this disclosure the user activity is synonymous with user actions and monitoring user behavior is synonymous with generating business intelligence.

The system 100 may make use of services provided by the Short Message Service (SMS).

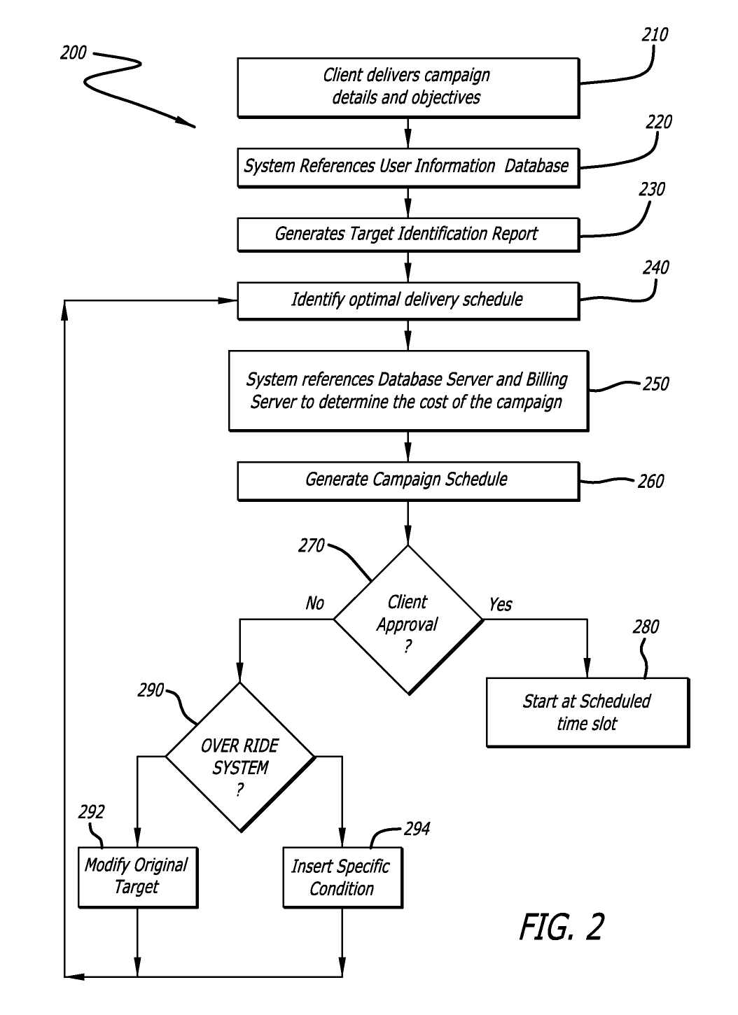

FIG. 2 is a process flow diagram, showing an illustrative embodiment for advertising process flow operations 200. Operational flow begins in initialization operation 210 with a client delivering advertising campaign objectives. The advertising campaign objectives being at least a general idea of a target audience based on demographics particular to a promotion for a good or service. Control transfers to operation 220.

In operation 220, the server 40 references user preferences and user activity data stored in the database 36. A user of a portable communication device 12 agrees to accept a predetermined number multimedia advertisements in exchange for credit or vouchers that may be used for purchases, discounted products or airtime. Upon agreement, the user will register with the system 100 through a website and fill out a questionnaire. Registration being for at least inputting name, age, gender and preferably including a questionnaire being for determining, categorizing and inputting the users consumer preferences as to enable the system 100 to individualize the offers and advertisements sent to the user's portable communication device 12. Registration may be updated and further refined through the website at any time by the user also. Control transfers to operation 230.

In operation 230, the server 40 generates a target identification report that at least includes identifying users that will most likely be responsive to an advertisement campaign based on previous user activity and user preferences inputted at the time of registration or change through the website. Control transfers to operation 240.

In operation 240, the server 40 identifies an optimal delivery schedule based on the target identification report generated in operation 230. The optimal delivery schedule being the time of day a user of a portable communication device will be most likely to respond to a particular advertisement. The optimal delivery time being determined from user behavioral patterns, user activity monitored by the system 100 and stored in database 36, and timeslot availability.

Preferably, the system 100 limits the number of advertisements a user receives, thereby limiting the number of available time slots. The server 40 predicts, from user behavioral patterns, an optimal advertisement delivery time where the user will be most likely to respond to the advertisement.

In an illustrative embodiment in accordance with the present disclosure, an advertisement for a soft drink may scheduled to be sent to the portable communication device 12 on hot summer days when the temperature exceeds 78 degrees Fahrenheit. In another embodiment, the advertisement may be 2 for 1 soft drink offers available at, for example, 7-11. Additionally, the advertisements may be location specific; in the 2 for 1 soft drink example, the soft drink offer may only be sent to users in beach communities or, in another example, drink specials may be sent to Hollywood residence between the ages of 21 through 35 for a particular Hollywood club promotion.

In addition to being location specific, the advertisements may be time specific as well. In a illustrative embodiment in accordance with the present disclosure, Starbucks specials may be sent to users of portable communication device 12 at 8 am, just in time for their morning coffee. Additionally, multiple advertisements may be sent over the course of a few weeks wherein viewing each advertisement through this period results in an excusive offer such as watching three movie trailers within a specified time results in two free tickets to the premier showing.

The advertisement may contain a voucher from the advertiser (for example, a 2 for the price offer). The voucher, which may be in the form of a bar code or a coupon, may be stored as a JPEG image on the portable communication device 12. The voucher being with and retrievable by the user whenever they go shopping, so long as the portable communication device 12 is with them at that time. In addition, the communication capability of the portable communication device 12 allows a user to call or text message in response to an advertisement or offer. Control transfers to operation 250.

In operation 250, the system 100 references a controller 50, a processing unit of server 40, being for determining the schedule of delivery for the advertisement and being in communication with the billing server 56 for determining what price to charge the client for delivery to the user and generating a cost summary report. The report being for predicting how much the delivery of the advertisement may cost the client based on the anticipated user viewing numbers. Preferably, the client will be charged for advertisements viewed by the user of the portable communication device 12 and not charged for sent and not viewed advertisements. In the event that more than two clients request a particular timeslot the system 100 initiates a bidding process wherein the highest bidder may transmit their advertisement in the particular timeslot. Control transfers to operation 260.

In operation 260, the schedule is determined and stored in memory of the database 36 being accessible by the controller 50. Control transfers to decision operation 270.

In decision operation 270 the schedule and cost of delivering the advertisement is presented to the client for their approval. If the client approves, control transfers to operation 280 where the controller 50 transmits the advertisement via a transceiver 51 and through a streaming data network 16 to predetermined portable communication devices 12 in accordance with the schedule. If the client is unhappy with any part of the generated advertisement, control transfers to decision operation 290. The advertisement maybe transmitted through a wireless network provided by a wireless network operator or a Mobile Virtual Network Operator (MVNO) or any other licensed Network airtime provider, preferably a technology such as WiMAX, and is delivered to the device 12.

In decision operation 290, a system administrator overrides the system 100 and consults the client for suggested changes. The changes may be one of modifying the original target audience in operation 292 or inserting an additional specific condition in operation 294 to narrow or hone in on the objectives, whereby the process flow operations loop back to operation 210 and start again until the client is satisfied with every aspect of the advertisement delivery.

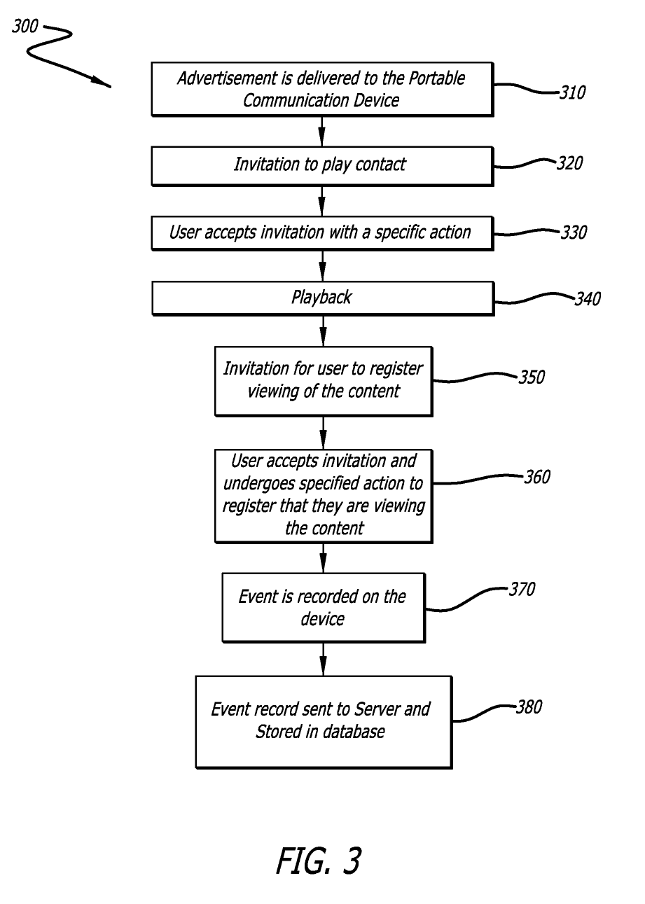

FIG. 3 is a process flow diagram, showing an illustrative embodiment for advertising process flow operations 300. Operational flow begins in initialization operation 310 with the advertisement being delivered to the portable communication device 12 from the server 40. Control transfers to operation 320.

In operation 320, the user receives an invitation that an advertisement is incoming and the user is invited to play the content. Control transfers to operation 330.

In operation 330, the user accepts the invitation to play the advertisement with a specific action. The action being at least one of a voice command, pressing an initiate button or pressing a touch screen. Control transfers to operation 340.

In operation 340, the advertisement is played on the interface of the portable communication device 12.

In the event that a call is received during playback of an advertisement, the outputting of the advertisement media may be postponed. When a call is either initiated or received by the user, the portable communication device 12 having a buffer being for temporarily storing advertisement media data streaming to the portable communication device 12 during a call. Temporarily storing the media allows for later playback and enables advertisement media output continuity upon completion of the call by the user.

Alternatively, a notification may be transmitted to the server 40 from the portable communication device 12 in the event of a call is either initiated or received. The notification being for temporarily pausing the streaming advertisement media data transmission until the call is completed. Upon call completion, another notification may be sent to the server from the portable communication device 12 for resuming streaming advertisement media data transmission so as to enable advertisement media output continuity upon completion of the call either initiate or received by the user. The notification may be a signal utilizing the Short Message Service (SMS). Control transfers to operation 350.

In operation 350, playback has concluded and the user receives an invitation to register viewing the content of the advertisement. Control transfers to operation 360.

In operation 360, the user undergoes a specific action to register that they have viewed the content of the advertisement. Registering viewing of the advertisement being for crediting the user viewing the advertisement. The credit may be in the form of points usable for purchases or digital coupons for special offers related to the advertisement. Control then transfers to operation 370.

In operation 370, the portable communication device records the action taken by the user to view and register that particular advertisement. Operation is then transferred to operation 380.

In operation 380, the record of the event is delivered to the server 40 and stored in the database 36, thus concluding the process flow operations. The record includes the time and all recordable metrics specific to the users actions regarding the content of the advertisement, which over time will be used to send the user more specifically catered advertisements and offers specific to the users interests and tastes.

In an illustrative embodiment in accordance with the present disclosure, FIG. 3 shows a process flow diagram for a process of inviting a user of the portable communication device 12 to view additional media being related to a previously viewed advertisement.

Operational flow begins just after an advertisement is viewed by a user in operation 410. Control transfers to operation 420.

In operation 420, the user goes through the same specific action described above to register viewing the advertisement. Control then transfers to operation 430.

In operation 430, the user receives an invitation to receive additional digital media content relating to the previously viewed advertisement. The invitation to view additional digital content may be in response to specific actions initiated by the user, actions that the controller 50 uses to calculate a high likelihood that the user will be responsive to the additional digital media content. Control then transfers to decision operation 440.

In decision operation 440, the user either agrees to view the additional content, wherein control transfers to operation 450 or the user declines viewing additional media content and control transfers to conclusion operation where the portable communication device 12 records the actions of the user.

In operation 450, the additional media is viewed by the user (playback initiated). Control then transfers to operation 460.

In operation 460, the user is offered to save the additional digital media file either to the portable communication device 12 or to another device such as a home computer. Operations are then concluded when control transfers to the final operation 470, wherein the portable communication device 12 records comprehensive feedback regarding the delivery, playback and subsequent consumer responses and forwards the recorded information from the device 12 is received via the transceiver 51 and directed by the controller 50 to a database 36. The database 36 may be accessible to advertisers via the web interface 21 and web server 64. Information from the device 12 is, therefore, received via the transceiver 51 and directed by the controller 50 to a database 36 to update the users profile. The database 36 may be accessible to advertisers via the web interface 21 and web server 64.

In the illustrative embodiment, feedback is produced to provide information on key aspects of the process. For example, the next time the mobile device logs into the server it might report back on: Registration information of the mobile device; Playback of each advertisement; played ok (including time of playback); which advertisements expired before playback could be attempted; users actions taken; advertisements saved for future viewing; advertisements discarded after playback; and advertisements viewed again.

The advertiser may be provided with an advertisement transmission report. The only parts of this process that the user should be aware of after opting-in and providing their web based “entertainment interests” should be from the notifications of media to be played and the saving (or not saving) of the media. The rest should be invisible to the user.

The transmission report will allow the advertiser to know which advertisements were: successfully received by the device; successfully played through the device and at what time; and saved by the user.

The advertiser may further provide a “find my nearest store” option at the end of the advertisements making use of a GPS capability.

The solution might be: user selects ‘find nearest store.’ this then interrogates the a database and returns a map plus routing information.

In an illustrative embodiment, a method for sending multimedia advertisements to a single hand portable communication device being single hand operable in accordance with the present disclosure is described. The method comprises: registering a user of a portable communication device 12, wherein registration at least being for inputting user preference data; monitoring user activity, wherein user activity at least includes monitoring hours of portable communication device usage, media viewed, and subsequent user actions upon viewing media and wherein the user activity is stored as user activity data in a database; performing calculations on a server 40 based on user preference data and user activity data, the calculations being for determining at least a target audience, an advertisement media presentation, an advertisement media delivery time and a time minimizing advertisement media delivery route for advertisements to be delivered to the portable communication device; and transmitting the advertisement media via a streaming data network 16 to the portable communication device 12.

In one instance, after outputting the advertisement media an invitation to receive additional media may be delivered to the portable communication device 12. The additional media being related to the advertisement media.

In one instance, the outputting of the advertisement media is postponed when a call is either initiated or received by a user, wherein the portable communication device 12 having a buffer being for temporarily storing advertisement media data streaming to the portable communication device during a call so as to enable advertisement media output continuity upon completion of the call either initiate or received by the user. Alternatively, a notification may be transmitted to the server 40 from the portable communication device 12 when either the call is initiated or received, the notification being for temporarily pausing streaming advertisement media data transmission until the call is completed. Another notification may be sent to the server 40 from the portable communication device 12 when the call is completed for resuming streaming advertisement media data transmission so as to enable advertisement media output continuity upon completion of the call either initiate or received by the user.

In one instance, the streaming data network is a Worldwide Interoperability for Microwave Access (WiMax) network. In another instance, the advertisement being an offer exclusive for at least one of a particular time and location. In another instance, a user may register viewing of an advertisement and receive a credit for registering viewing of the advertisement, the credit being usable for purchases. In another instance, the advertisement may be transmitted in response to predetermined environmental conditions.

In one instance, an advertiser may be billed based on substantially real time demand for at lease one of a timeslot and user demographics; and initiate a bidding process for determining a timeslot price among advertisers demanding a same timeslot.

In one instance, the server may 40 allow overrides to the server determined timeslot by a content deliverer.

In one instance, the monitoring of user activity includes collecting business intelligence on users that indicate an optimal time to transmit the advertisement media to a user's portable communication device and the time of day the user is most likely to respond to the advertisement media.

In one instance, the method identifies a geographic location of the user and transmitting advertisement media being substantially related to that location.

In one instance, the portable communication device is a cell phone and includes a user interface being of a dimension less than 3 square inches in surface area and wherein the mobile communication device being for receiving streaming real time emergency information relevant to a location.

In an illustrative embodiment, in accordance with the present disclosure, a method for streaming multimedia advertisements to a single hand held portable communication device being single hand operable, comprises; receiving a client's advertising campaign objectives; storing user data and advertisement media, wherein the user data is at least one of information inputted by the user and user system activity; monitoring user system activity; performing calculations on a server for determining at least a target audience, an advertisement media presentation, an advertisement media delivery time and an time minimizing advertisement media delivery route from the user data that substantially meets the client's advertising campaign objectives, wherein the server monitors the user activity in substantially real time for continuously modifying at least the target audience, the advertisement media presentation, the advertisement media delivery time and the least expensive advertisement media delivery route; transmitting the advertisement media via a streaming data network to the portable communication device, wherein a portable communication device being for receiving and outputting advertisement media from the server and for sending user activity to the server.

In one instance, after outputting the advertisement media an invitation to receive additional media may be delivered to the portable communication device 12. The additional media being related to the advertisement media.

In one instance, the outputting of the advertisement media is postponed when a call is either initiated or received by a user, wherein the portable communication device 12 having a buffer being for temporarily storing advertisement media data streaming to the portable communication device during a call so as to enable advertisement media output continuity upon completion of the call either initiate or received by the user. Alternatively, a notification may be transmitted to the server 40 from the portable communication device 12 when either the call is initiated or received, the notification being for temporarily pausing streaming advertisement media data transmission until the call is completed. Another notification may be sent to the server 40 from the portable communication device 12 when the call is completed for resuming streaming advertisement media data transmission so as to enable advertisement media output continuity upon completion of the call either initiate or received by the user.

In one instance, the streaming data network is a Worldwide Interoperability for Microwave Access (WiMax) network. In another instance, the advertisement being an offer exclusive for at least one of a particular time and location. In another instance, a user may register viewing of an advertisement and receive a credit for registering viewing of the advertisement, the credit being usable for purchases. In another instance, the advertisement may be transmitted in response to predetermined environmental conditions.

In one instance, an advertiser may be billed based on substantially real time demand for at lease one of a timeslot and user demographics; and initiate a bidding process for determining a timeslot price among advertisers demanding a same timeslot.

In one instance, the server may 40 allow overrides to the server determined timeslot by a content deliverer.

In one instance, the monitoring of user activity includes collecting business intelligence on users that indicate an optimal time to transmit the advertisement media to a user's portable communication device and the time of day the user is most likely to respond to the advertisement media.

In one instance, the method identifies a geographic location of the user and transmitting advertisement media being substantially related to that location.

In one instance, the portable communication device is a cell phone and includes a user interface being of a dimension less than 3 square inches in surface area and wherein the mobile communication device being for receiving streaming real time emergency information relevant to a location and wherein the advertisement and emergency information being deliverable in less than 5 minutes.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method for sending multimedia advertisements to a single handheld portable communication device being single-hand operable, comprising:
registering a user of a portable communication device, wherein registration at least being for inputting user preference data;
monitoring user activity, wherein user activity at least includes monitoring media viewed by the user, and subsequent user actions upon viewing media and wherein the user activity is stored as user activity data in a database;
performing calculations on a server based on user preference data and user activity data, the calculations being for determining at least a target audience, an advertisement media presentation, an advertisement media delivery time and an time minimizing advertisement media delivery route for advertisements to be delivered to the portable communication device; and
transmitting the advertisement media via a streaming data network to the portable communication device.

2. The method of claim 1, wherein after outputting the advertisement media an invitation to receive additional media is delivered to the portable communication device.

3. The method of claim 2, wherein the additional media being related to the advertisement media.

4. The method of claim 1, wherein the outputting of the advertisement media is postponed when a call is either initiated or received by a user.

5. The method of claim 4, wherein the portable communication device having a buffer being for temporarily storing advertisement media data streaming to the portable communication device during a call so as to enable advertisement media output continuity upon completion of the call either initiate or received by the user.

6. The method of claim 4, wherein a notification is transmitted to the server from the portable communication device when either the call is initiated or received, the notification being for temporarily pausing streaming advertisement media data transmission until the call is completed and wherein another notification is sent to the server from the portable communication device when the call is completed for resuming streaming advertisement media data transmission so as to enable advertisement media output continuity upon completion of the call either initiate or received by the user.

7. The method of claim 1, wherein the streaming data network is a Worldwide Interoperability for Microwave Access (WiMax) network and.

8. The method of claim 1, wherein the advertisement being an offer exclusive for at least one of a particular time and location.

9. The method of claim 1, further comprising registering viewing of the advertisement by a user.

10. The method of claim 8, further comprising receiving a credit for registering viewing of the advertisement, wherein the credit being usable for purchases.

11. The method of claim 1, wherein the advertisement is transmitted in response to predetermined environmental conditions.

12. The method of claim 1, further comprising:
billing an advertiser based on substantially real time demand for at lease one of a timeslot and user demographics; and
bidding for a timeslot price among advertisers demanding a same timeslot.

13. The method of claim 12, wherein the server will allow overrides to the server determined timeslot by a content deliverer.

14. The method of claim 1, wherein the monitoring of user activity includes collecting business intelligence on users that indicate an optimal time to transmit the advertisement media to a user's portable communication device and the time of day the user is most likely to respond to the advertisement media.

15. The method of claim 1, further comprising identifying a geographic location of the user and transmitting advertisement media being substantially related to that location.

16. The method of claim 1, wherein the portable communication device is a cell phone and includes a user interface being of a dimension less than 3 square inches in surface area.

17. The method of claim 1, wherein the mobile communication device being for receiving substantially real time emergency information relevant to a location and wherein the advertisement and emergency information being deliverable in less than 5 minutes.

18. A method for sending multimedia advertisements to a single handheld portable communication device being single-hand operable, comprising:
receiving a client's advertising campaign objectives;
storing user data and advertisement media, wherein the user data is at least one of information inputted by the user and user system activity;
monitoring user system activity;
performing calculations on a server for determining at least a target audience, an advertisement media presentation, an advertisement media delivery time and a time minimizing advertisement media delivery route from the user data that substantially meets the client's advertising campaign objectives, wherein the server monitors the user activity in substantially real time for continuously modifying at least the target audience, the advertisement media presentation, the advertisement media delivery time and the least expensive advertisement media delivery route;
transmitting the advertisement media via a streaming data network to the portable communication device, wherein a portable communication device being for receiving and outputting advertisement media from the server and for sending user activity to the server.

19. The method of claim 18, wherein after outputting the advertisement media an invitation to receive additional media is delivered to the portable communication device.

20. The method of claim 19, wherein the additional media being related to the advertisement media.

21. The method of claim 18, wherein the outputting of the advertisement media is postponed when a call is either initiated or received by a user.

22. The method of claim 21, wherein the portable communication device having a buffer being for temporarily storing advertisement media data streaming to the portable communication device during a call so as to enable advertisement media output continuity upon completion of the call either initiate or received by the user.

23. The method of claim 21, wherein a notification is transmitted to the server from the portable communication device when either the call is initiated or received, the notification being for temporarily pausing streaming advertisement media data transmission until the call is completed and wherein another notification is sent to the server from the portable communication device when the call is completed for resuming streaming advertisement media data transmission so as to enable advertisement media output continuity upon completion of the call either initiate or received by the user.

24. The method of claim 18, wherein the streaming data network is a Worldwide Interoperability for Microwave Access (WiMax) network.

25. The method of claim 18, wherein the advertisement being an offer exclusive for at least one of a particular time and location.

26. The method of claim 18, further comprising registering viewing of the advertisement by a user.

27. The method of claim 25, further comprising receiving a credit for registering viewing of the advertisement, wherein the credit being usable for purchases.

28. The method of claim 18, wherein the advertisement is transmitted in response to predetermined environmental conditions.

29. The method of claim 18, further comprising:
billing an advertiser based on substantially real time demand for at lease one of a timeslot and user demographics; and
bidding for a timeslot price among advertisers demanding a same timeslot.

30. The method of claim 29, wherein the server will allow overrides to the server determined timeslot by a content deliverer.

31. The method of claim 18, wherein the monitoring of user activity includes collecting business intelligence on users that indicate an optimal time to transmit the advertisement media to a user's portable communication device and the time of day the user is most likely to respond to the advertisement media.

32. The method of claim 18, further comprising identifying a geographic location of the user and transmitting advertisement media being substantially related to that location.

33. The method of claim 18 wherein the portable communication device is a cell phone and includes a user interface being of a dimension less than 3 square inches in surface area.

34. The method of claim 18, wherein the mobile communication device being for receiving streaming real time emergency information relevant to a location and formation being deliverable in less than 5 minutes.
